(19) United States
(12) Patent Application Publication
(10) Pub. No.: US 2002/0058133 A1
(43) Pub. Date: May 16, 2002

(54) Low-skew magnetic tape carrier film

(76) Inventors: Harald Mueller, Taunusstein (DE); Ursula Murschall, Nierstein (DE); Cynthia Bennett, Alzey (DE)

Correspondence Address: PROPAT, L.L.C., 2912 CROSBY ROAD, CHARLOTTE, NC, 28211-2815, US

(21) Appl. No.: 09/939,482

(22) Filed: Aug. 24, 2001

(30) Foreign Application Priority Data
Sep. 15, 2000 (DE) 100 45 602.2

(51) Int. Cl. B32B 27/36; B29C 47/06; B29C 55/12; B29C 71/02

(52) U.S. Cl. 428/220; 428/480; 428/910; 264/173.16; 264/210.5; 264/210.7; 264/211.12; 264/235.8

(57) ABSTRACT

The invention relates to a single-layered or multi-layered biaxially-oriented film, which mainly consists of a crystallizeable thermoplastic polyester and which has a total thickness ranging from 4 to 25 μm. The film which is provided with a magnetic coating has a skew value of ≦1 [symbol] . The invention also relates to a process for the production of this film which comprises the melting of the thermoplastic polyester in an extruder, extruding it through a flat-film die (slot die), and chilling it thereafter in order to obtain a prefilm. The prefilm is then stretched, the stretched film is thermofixed and the thermofixed final film is seamed and wound up. After the winding process the film roll is, submitted to an aging process.

### BACKGROUND OF THE INVENTION

1. Field of the Invention

The invention relates to a single-layered or multi-layered biaxially-oriented film, predominantly made of a crystallizeable thermoplastic polyester with a total thickness lying within the range from 4 to 24 μm. The film has an extremely low skew once the magnetic coating has been applied. The invention also relates to a process for the production and to the use of this film.

2. Description of the Related Art

Biaxially-oriented thermoplastic polyester films, especially when they are made of polyethylene terephthalate (PET), polyethylene naphthalate (PEN), polytertamethylene terephthalate (PBT) or polycyclohexanedimethanol terephthalate, are used due to their inherent superior properties such as tensile strength, their E-module, their transparency, their chemical and thermal stability to a great extent in numerous fields of technical applications, e.g. when used as carrier films for magnetic recording media, such as audio-, video- and computer tapes as well as floppy disks, thermo printing tapes, capacitors etc.

In order to be suitable for use in the various fields of application the polyester films have to meet specific requirements which are usually met either by the way the raw materials are composed or by way of particular process technologies during the film production.

For example: Apart from fulfilling the need of a good and steady running property and a high abrasion-resistance, video-tape carrier films have to meet especially high requirements in terms of surface homogenity, homogenity of the static behaviour and a low skew, since unwanted protrusions at the surface, electrostatic faults such as static marks, high static electricity and a longitudinal skew within the magnetic coating, once applied to this surface at a later time, may lead to losses of information and disturbances of the electromagnetic recordings, thus considerably reducing the range of technical applications of the information carrier.

It is part of the state-of-the-art technology to eliminate or respectively reduce the mentioned electrostatic faults and high electromagnetic charging at the surface by incorporating anorganic and/or organic inert particles with a defined particle size distribution. Examples of such inert particles which can be used either as stand-alone particles or which may be combined with oneanother are CaCO₃, TiO₂, Al₂O₃, ZrO₂, BaSO₄, calcium phosphate, kaolin, SiO₂, or natural and synthetic silicates.

These inert particles undergo a surface treatment, depending on their chemical composition, in order to improve their affinity to the polymer matrix and, thus, to improve the quality, i.e. the properties of the molded articles produced by using these inert particles.

A diagram of the different ways to achieve a surface modification of carbonatic filling materials which has the object of taking influence on the interaction in the boundary layers of especially CaCO₃/polymere is depicted on page 269 of Plaste und Kautschuk, 37^{th} annual set, number 8/1990.

U.S. Pat. No. 3,227,675 describes the treatment of “clays” (kaolins) with organo-silicon compounds in order to achieve a better integration into a polymer matrix.

DE-A-35 34 143 describes mono-dispersed SiO₂ particles, especially made for chromatographic purposes, the functional groups of which are at the surface and were reacted with organo-trialkoxysilanes without having an adverse effect on the former properties of the particles.

A method for the modification of synthetic silicate filling materials containing sulphurous organo-silicon compounds for an improved integration into vulcanizeable caoutchouc mixtures is described in EP-A-0 177 674.

U.S. Pat. No. 4,567,030 also describes mono disperse particles of mixed oxides which can be used as “fillers”, the surface of which can be modified with a aminopropyl trimethoxysilane or silanes which contain ethylenically unsaturated groups, in order to improve the moisture resistance and the “disperseability in resin” i.e. in order to reduce the formation of agglomerates.

EP-A-0 236 945 points out that in order to reduce the formation of agglomerates during the polymerisation process it is useful to submit the mono disperse particles of mixed oxides to a treatment with a silane-, titanium- or aluminum-coupling agent.

In all these documents no ways are shown of how the longitudinal shrinkage (skew) can be reduced or be avoided.

Skew is a property inherent in polyesters. Skew is a longitudinal shrinkage, i.e. a shrinkage in longitudinal direction of the film after it has been produced and which is caused by strain which the film has been exposed to after the thermofixing.

### SUMMARY OF THE INVENTION

It was therefore the object of the invention to provide a biaxially-oriented, at least single-layered polyester film with a total thickness of 4 to 25 μm which guarantees an excellent picture reproduction by the carrier film, once the magnetic coating has been applied.

This object is solved by a single-layered or multi-layered biaxially-oriented film, mainly made of a crystallizeable thermoplastic polyester with a total thickness lying within the range from 4 to 25 μm, wherein the skew of the coated magnetic film, consisting of the carrier film and the magnetic coating, is ≦1 [symbol] , preferably ≦0.8 [symbol] , especially preferred ≦0.7 [symbol] .

A skew of ≦2.0 [symbol] within the magnetic film leads to losses of information and adverse effects on its electromagnetic properties. The information carrier is technically unusable.

A skew of 2.0 [symbol] to 1 [symbol] within the coated magnetic film leads to distortions of the picture during video recordings, which renders the information carrier only limited usable.

A coated magnetic tape film with a skew lying within the range from ≦1 [symbol] , preferably ≦0.8 [symbol] and especially preferred ≦0.7 [symbol] is an information carrier with an excellent picture reproduction. As a rule, the skew of the uncoated film is by 0.2 [symbol] lower than the skew of the coated film.

The films according to the present invention can be single- or multi-layered, they can have a symmetrical or an unsymmetrical structure, wherein differently composed polyesters, i.e. polyesters containing additional additives, respectively composed and non-composed polyesters, or polyesters of the same chemical compound but with a different molecular weight and a different viscosity are combined by way of coextrusion.

The film according to the invention mainly consists of a crystallizeable polyethylene terephthalate (PET), of a crystallizeable polyethylene naphthalate (PEN), or mixtures thereof.

Crystallizeable PET or crystallizeable PEN means

crystallizeable homopolymeres

crystallizeable compounds

crystallizeable copolymeres

crystallizeable recycled material

other variations of crystallizeable polyester.

Polyester can either be produced according to the ester interchange process, e.g. catalyzed by ester interchange catalysts, such as Zn-, Mg-, Ca-, Mn-, Li-, or Ge-salts, or according to the direct ester process (PTA method), where antimone compounds are used as polycondensation catalysts and phosphorus compounds as stabilizers. The IV-value (intrinsic viscosity) of the polyesters preferably lies within the range from 0.5 to 1.0 dl/g.

Examples of polyesters are polycondensates made of terephthalic acid, isophthalic acid or 2,6-naphthalene dicarboxylic acid containing glycols with 2 to 10 carbon atoms such as polyethylene terephthalate, polybutylene terephthalate, poly-1,4-cyclohexylene-dimethylene terephthalate, polyethylene-2,6-naphthalene dicarboxylate, polyethylene naphthalate/bibenzoate or polyethylene-p-hydroxy-benzoate.

The polyesters can be made of comonomer units of up to 50 mol %, especially of up to 30 mol %, whereby a variation of the glycol- and/or acid component is possible. Among other acids the copolyesters can contain as acid components 4,4′-bibenzoic acid, adipic acid, glutaric acid, succinic acid, sebacic acid, phthalic acid, isophthalic acid, 5-Na-sulfoisophthalic acid or polyfunctional acids such as trimelitic acid.

The polyester films can be produced according to known methods of a polyester raw material, optionally with other raw materials and/or further additives customarily used for the manufacture of technical films at usual quantities of 0.1 to a maximum of 20% by weight, either as a monofilm or as multi-layered, optionally coextruded films, with either equally or differently structured surfaces, wherein, for example, one surface is pigmented, and the other surface contains no pigment or less pigments. In that manner one or both surfaces of the films can be provided with a customary functional coating in accordance with known methods.

While trying to reduce the skew, the tension during the winding process of the film was reduced, since high drawing forces and fluctuations of the tension during the winding often cause distortions within the film. Low drawing forces, however, led to soft coils and to the winding problems associated with them, such as telescoping and especially static marks, which also have strong adverse effects on the quality of the video picture, and eventually render the film useless.

The invention therefore also relates to a new method for the production of the biaxially-oriented films made of thermoplastic polyester with a low skew, a method which comprises the melting of the thermoplastic polyester in an extruder, extruding it through a flat-film die (slot die) and chilling it thereafter in order to obtain a prefilm, stretching the prefilm, thermofixing the stretched prefilm, and then seaming and winding the thermo-fixed final film, wherein the film, once wound-up, is submitted to an aging process.

### DETAILED DESCRIPTION OF PREFERRED EMBODIMENTS

The preferred extrusion method for the production of the polyester film comprises extruding the melted polyester material through a flat-film die (slot die) and chilling it as a mainly amorphous prefilm on a quenching roll. This prefilm is reheated thereafter and stretched in the machine direction (MD) and in the transverse direction (TD), respectively in TD and in MD, respectively in MD, TD and again in MD and/or in TD. The stretching temperatures are generally within the range from T_{g}+10 K to T_{g}+60 K (T_{g}=glass transition temperature), the length stretch ratio is within the range from 2 to 6, especially from 3 to 4.5, the transverse stretch ratio is within the range from 2 to 5, especially from 3 to 4.5, and the ratio of the optionally performed second length stretching is within the range from 1.1 to 3. As an option the first length stretching can be simultaniously performed with the transverse stretching (simultanious stretching). Subsequently the thermofixing of the film is done in a tenter frame at frame temperatures lying within the range from 150 to 250° C., especially from 170 to 240° C.

According to the invention, the aging of the wound-up film is performed by way of storing it for a period of at least 30 days at ambient air temperature, preferably of at least 35 days, especially preferred of at least 40 days, also at ambient air temperature. The duration of the ageing process can, however, be shortened, if the temperature at which the aging process takes place is increased.

It was more than a surprise for the experts when they learned that the aging process, performed by deliberate storing of the uncoated film rolls eventually at higher temperatures reduces the skew of the film provided with a magnetic coating at a later time.

A PET film roll, once the magnetic coating has been applied, has skew values lying within the range from 1.5 [symbol] to 1.8 [symbol] . Other PET film rolls which had been stored over a time period of 20 days at a temperature of 10° C. had skew values of 1.2 [symbol] to 1.4 [symbol] after the application of the magnetic coating.

PET film rolls stored at a temperature of 10° C. for more than 50 days had skew values between 0.4 [symbol] to 0.6 [symbol] after the application of the coating.

Other PET film rolls stored for a period of only 4 days at a temperature of 50° C. had excellent skew values from 0.2 [symbol] to 0.35 [symbol] after the magnetic coating had been applied.

During the thermo treating of the film it has to be observed, however, that the cooling process is performed as slowly as possible since rapid temperature changes may lead to new tensions within the film roll, thus leading to a new skew.

In addition to that, temperature shocks, especially low-temperature shocks, should be avoided after the aging process at increased temperatures has taken place.

Low-temperature shocks lead to a build-up of significant tensions which initially begin to develop in the outer film layers.

Minimum temperatures for the ageing process according to the invention ideally are in the area of 10 K below the glass transition temperature T_{g} of the polyester used, preferably 20 K below and especially preferred 25 K below T_{S}.

After winding the film to customer rolls these rolls are stored, according to the invention, over a time period of at least 4 days at a temperature of 50° C., or over a time period of at least 15 days at a temperature of 30° C., or over a time period of at least 40 days at temperatures between 10° C. to 20° C., so that the skew of the film which receives its coating at a later time stabilizes within the range according to the invention.

Due to its especially low skew value, a property according to this invention, the film according to this invention is especially suitable for the use as carrier film for video recordings and for computer tapes with a high data density.

The measurement of the individual properties is performed in accordance with the following standards, respectively methods.

### Skew

Film strips with a width of 1.2 cm (½ inch) are vertically suspended and pulled downwards with a force of 0.1 N. While being under this strain the exact length of the film strip is determined at ambient air temperature (23° C.). Still under a strain of 0.1 N, the film strips are then thermo treated in an oven at a temperature of 50° C. for a period of 18 hours. The relative humidity of the air supplied to the oven is 50% at a temperature of 23° C.

After removing the film strips from the oven they are cooled back down to ambient air temperature (23° C.), and after a waiting period of 1 hour the length of the strips is measured. The relative change in length resulting from the thermo-treatment is the skew value.

With of this method the skew of the uncoated film as well as the skew of the coated film can be determined.

### Average Thickness

The average thickness d_{F} of a film is determined by its weight (better: its mass) at a given length, width and density. The weight of a film strip taken from the middle of a sample which extends across the entire width of the roll is measured after it has been prepared on the cutting table. The value d_{F} is then determined by the following formula (please observe the dimensions):

$${d}_{F} ( μ m ) = \frac{m [ g ]}{l [ mm ] \cdot b [ mm ] \cdot d [ g / {cm}^{3} ]} \cdot {10}^{6}$$

with the following applying

m=mass of the pice of film

l=length of the sample

b=width of the sample

d=density of the examined material

d=1.395 g/cm³ for polyester

After the individual sample strips have been cut, their weight is determined using an analytical scale, type Mettler PM 200 (maximum weight 200 g). A computer type HP Vectra ES/12 connected to the scale determins the average thickness using all necessary parameters.

### IV-Value (DCE)

The standard viscosity SV (DCE) is measured in accordance with DIN 53726 in dichloro acetic acid. The intrinsic viscosity (IV) is determined by the standard viscosity as follows:

IV(DCE)=6.67×10⁻⁴SV(DCE)+0.118.

### Glass Transition Temperature T_{g}

The glass transition temperature T_{g} is determined by a Perkin Elmer Pyres 1 DSC (Differential Scanning Caloriemeter). The glass transition is the average temperature of the gradual change in thermal capacity.

### EXAMPLE 1

Chips made of polyethylene terephthalate (produced via the ester interchange process with Mn as ester interchange catalyst; Mn-concentration 100 ppm) with a SV-value of 810 and containing an amount of 3000 ppm of CaCO₃-particles with an average particle diameter of 0.7 μm were dried at a temperature of 160° C. to a residual humidity of 50 ppm and put through an extruder thereafter. By a subsequent sequential length- and transverse stretching followed by a thermofixing process, a single-layered film with a thickness of 13 μm was produced at a machine speed of 350 m/min. The film was wound up thereafter to a master roll with a running length of 46.000 m.

The master roll was then transformed into customer rolls with a width of 646 mm and a running length of 23000 m. The uncoated customer rolls were stored for a period of 4 days at a temperature of 50° C. and then carefully cooled down to ambient air temperature (23° C.) for a period of 24 hours. The resulting skew value of the uncoated film versus the one of the film with a magnetic coating is shown in table1.

### EXAMPLE 2

Example 1 was repeated. Contrary to Example 1, however, a three-layered ABA film was produced by way of coextrusion technology, with B representing a base layer with a thickness of 11 μm and A representing the cover layers with a thickness of 1 μm each, covering the base layer on both sides.

The polyester raw material in the cover layers was identical to the one in the base layer in example 1.

The film was then transformed into customer rolls according to example 1, stored for a period of 15 days at a temperature of 30° C. and then cooled down to room temperature within 12 hours. The skew values of the film in example 2 are shown in table1.

### Comparative Example 1

Example 1 was repeated. In contrast to Example 1, however, the customer rolls were stored over a period of 4 days at a temperature of 10° C.

The skew values of the film in comparative Example 1 are shown in table 1.

### Comparative Example 2

Example 2 was repeated. But in contrast to Example 2 the customer rolls were stored outside in the open air for a period of 15 days at an average temperature of 10° C.

The skew values measured in the film according to comparative Example 2 are also shown in table 1.

TABLE 1

| | | | Skew value of the |
|---|---|---|---|
| | | Skew value of | coated film, i.e. after |
| | Thickness | the uncoated | application of the |
| | of the film | film | magnetic coating |
| | (μm) | 0/00 | 0/00 |
| Example 1 | 13 | 0.10 | 0.3 |
| Example 2 | 13 | 0.05 | 0.25 |
| Vergleichsbeispiel 1 | 13 | 1.4 | 1.6 |
| Vergleichsbeispiel 2 | 13 | 1.1 | 1.3 |

It is evident that the films manufactured and aged according to this invention, had skew values within the range claimed in the invention, whereas films which had been submitted to an aging process with a different set up were of a minor quality.

We claim:

1. Single-layered or multi-layered biaxially-oriented film, mainly made of a crystallizeable thermoplastic polyester with a total thickness of 4 to 25 μm, wherein the film, provided with a magnetic coating, has a skew-value of ≦1 [symbol] .

2. Film, as claimed in claim 1, wherein the film is multi-layered and has a symmetrical or an unsymmetrical structure, and wherein differently composed polyesters, or composed and non-composed polyesters, or polyesters of the same chemical compound, but with a different molecular mass and a different viscosity are combined by way of coextrusion.

3. Film, as claimed in claim 1, wherein said polyester has an IV-value which lies within a range from 0.5 to 1.0 dl/g.

4. Film, as claimed in claim 1, wherein the polyester is selected from the group of polycondensates made of terephthalic acid, isophthalic acid, or 2,6-naphthalene dicarboxylic acid containig glycols with 2 to 10 carbon atoms.

5. Film, as claimed in claim 1, wherein the polyester contains an amount of up to 50 mol % of comonomer units, wherein the comonomer units are contained as acid components.

6. Film, as claimed in claim 1, wherein one or more layer of the film contain additives in an amount ranging from 0.1 to 20% by weight.

7. Method of producing a biaxially-oriented film, made of thermoplastic polyester as claimed in claim 1, which comprises melting of the thermoplastic polyester in an extruder, extruding it through a flat-film die (slot die) and chilling it thereafter in order to obtain a prefilm, stretching the prefilm, thermofixing the stretched prefilm, and then seaming and winding the thermo-fixed final film, wherein the film, once wound-up, is submitted to an aging process.

8. Method, as claimed in claim 7, wherein the prefilm is reheated for stretching purposes, and then stretched in the machine direction (MD) and in the transverse direction (TD), respectively in TD and in MD, respectively in TD and again in MD or in TD or again in MD and in TD, wherein the temperatures used for the stretching process are within a range from T_{g}+10 K to T_{g}+60 K (T_{g}=glass transition temperature), wherein the lentgh stretch ratio is within a range from 2 to 6, and the transverse stretch ratio is within a range from 2 to 5.

9. Method, as claimed in claim 7, wherein, after the stretching, the thermofixing of the film takes place in a tenter frame at frame temperatures ranging from 150° C. to 250° C.

10. Method, as claimed in claim 7, wherein the aging of the wound-up film is performed by way of storing the film over a time period of at least 30 days at ambient air temperatures.

11. Method, as claimed in claim 7, wherein the aging process is performed at an increased temperature.

12. Method, as claimed in claim 11, wherein the storage time during the aging process is reduced in proportion to the increase in temperature.

13. Method, as claimed in claim 11, wherein the rolls resulting from the winding of the seamed, thermofixed final film are stored over a minimum time period of 4 days at a temperature of 50° C., or over a minimum time period of 15 days at a temperarure of 30° C., or over a minimum time period of 40 days at a temperarure of 10° C. to 20° C.
